(19) United States
(12) Patent Application Publication
(10) Pub. No.: US 2007/0122011 A1
(43) Pub. Date: May 31, 2007

(54) Face authentication system and gate management system

(75) Inventor: Kei Takizawa, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/606,005

(22) Filed: Nov. 30, 2006

(30) Foreign Application Priority Data
Nov. 30, 2005 (JP) 2005-345511

(51) Int. Cl. G06K 9/00

(52) U.S. Cl. 382/118

(57) ABSTRACT

A face authentication system which authenticates the faces of persons passing through at least two parallel passages before the persons reach predetermined positions includes a plurality of image sensing units arranged in the predetermined positions of the plurality of passages to record images of persons passing through the passages, a plurality of face authenticating units for checking whether the persons are preregistered persons, on the basis of the images obtained from the plurality of image sensing units, and a blind plate installed between every two adjacent passages making a pair among the plurality of passages to prevent the image sensing unit installed in one passage to record a person passing through the passage from recording a person passing through the other passage. The recording direction of the image sensing unit installed in one passage points to the other passage.

### CROSS-REFERENCE TO RELATED APPLICATIONS

This application is based upon and claims the benefit of priority from prior Japanese Patent Application No. 2005-345511, filed Nov. 30, 2005, the entire contents of which are incorporated herein by reference.

### BACKGROUND OF THE INVENTION

1. Field of the Invention

The present invention relates to a face authentication system which authenticates a visitor, i.e., checks whether the visitor is a preregistered person by collating a face image obtained from the visitor with preregistered dictionary information. The present invention also relates to a gate management system which manages entrance/exit with respect to an area such as a room or facility requiring security by using the face authentication system.

2. Description of the Related Art

Jpn. Pat. Appln. KOKAI Publication No. 2001-266152 discloses a technique concerning a gate management system using a face authentication apparatus. This gate management system has a camera such as a video camera as an image sensing means. When a person to be authenticated stops in front of the camera and turns his or her face to the lens of the camera, the camera records and inputs the face image of the person. The gate management system then checks whether the person is a preregistered person by collating face feature information obtained from the input face image and unique to the person with preregistered dictionary information. If the person is a preregistered person, the gate management system opens the door (gate) of an entrance/exit target area (a room or facility).

As described above, a face authentication apparatus of this type records the face of a person to be authenticated when he or she stops in front of the camera. Therefore, a demand has arisen for authenticating the face of a visitor (moving person) to be authenticated before the visitor comes close to the door. However, it is difficult to appropriately records the face of a walking person, so this demand cannot be met.

Accordingly, a face authentication apparatus which authenticates the face of a visitor before the visitor comes close to the door is recently developed. It is also possible to arrange a plurality of face authentication apparatuses in parallel and authenticate the faces of a plurality of visitors at once, in order to manage a large traffic volume.

Problems arising when a plurality of face authentication apparatuses are arranged in parallel will be explained below.

[Problem 1]

A person in an adjacent passage may appear in an input image of a face authentication apparatus, so the apparatus may authenticate this person in the adjacent passage by mistake.

[Problem 2]

A display unit in an adjacent passage comes in sight of a visitor. If the visitor watches this display unit in the adjacent passage, a face authentication apparatus supposed to authenticate the face of the visitor cannot accurately obtain a front face. This may decrease the accuracy of face authentication.

[Problem 3]

A visitor who has not passed face authentication must return a passage in the opposite direction. This causes a traffic jam.

### BRIEF SUMMARY OF THE INVENTION

It is, therefore, an object of the present invention to provide a face authentication system and gate management system which, when a plurality of face authentication apparatuses are arranged in parallel, prevent a person in a passage other than a passage of interest from appearing in an input image, thereby preventing a person in an adjacent passage from being authenticated by mistake.

It is another object of the present invention to provide a face authentication system and gate management system which, when a plurality of face authentication apparatuses are arranged in parallel, allow a passing person to easily find a target display means to watch, and stabilize the direction of the face of the passing person, thereby increasing the accuracy of face authentication.

It is still another object of the present invention to provide a face authentication system and gate management system which, when a plurality of face authentication apparatuses are arranged in parallel, can prevent a traffic jam even if face authentication has failed.

A face authentication system as an example of the present invention is a face authentication system which authenticates faces of persons passing through at least two parallel passages before the persons reach predetermined positions. This face authentication system comprises a plurality of image sensing means arranged in the predetermined positions of the plurality of passages to record images of persons passing through the passages, a plurality of face authenticating means for checking whether the persons are preregistered persons, on the basis of the images obtained from the plurality of image sensing means, and a blind plate installed between every two adjacent passages making a pair among the plurality of passages to prevent the image sensing means installed in one passage to record a person passing through the passage from recording a person passing through the other passage, wherein a recording direction of the image sensing means installed in one passage points to the other passage.

Also, a gate management system as an example of the present invention is a gate management system which authenticates faces of persons passing through at least two parallel passages before the persons reach entrance/exit gates, and controls opening/closing of the entrance/exit gates on the basis of authentication results. This gate management system comprises a plurality of image sensing means arranged in predetermined positions corresponding to the entrance/exit gates of the plurality of passages to record images of persons passing through the passages, a plurality of face authenticating means for checking whether the persons are preregistered persons, on the basis of the images obtained from the plurality of image sensing means, a plurality of gate control means for controlling opening/closing of the plurality of entrance/exit gates, on the basis of determination results from the plurality of face authenticating means, and a blind plate installed between every two adjacent passages making a pair among the plurality of passages to prevent the image sensing means installed in one passage to record a person passing through the passage from recording a person passing through the other passage, wherein a recording direction of the image sensing means installed in one passage points to the other passage.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the generation description given above and the detailed description of the embodiments given below, serve to explain the principles of the invention.

FIG. 1 is a schematic view showing the configuration of a gate management system to which a face authentication system according to an embodiment of the present invention is applied;

FIG. 2 is a block diagram showing the arrangement of a face authentication apparatus according to the embodiment of the present invention;

FIG. 3 is a flowchart for explaining an example of the procedure of processing of a gate controller;

FIG. 4 is a flowchart for explaining an example of the procedure of processing of a display/authentication controller;

FIGS. 5A to 5E are views showing examples of display windows on a display unit;

FIG. 6 is a view showing an example of an input image obtained from a camera;

FIG. 7 is a schematic view showing an example of a state in which a display unit is viewed in the directions of two adjacent passages;

FIG. 8 is a schematic view showing the arrangement of another face authentication apparatus which authenticates the face of a visitor before the visitor comes close to the door;

FIG. 9 is a schematic view showing a case in which a plurality of face authentication apparatuses shown in FIG. 8 are arranged in parallel in a place where many visitors pass;

FIG. 10 is a plan view of FIG. 9;

FIG. 11 is a view showing another example of the input image obtained from the camera;

FIG. 12 is a schematic view showing another example of the state in which the display unit is viewed in the directions of two adjacent passages; and

FIG. 13 is a schematic view for explaining the operation timings of the face authentication apparatus.

### DETAILED DESCRIPTION OF THE INVENTION

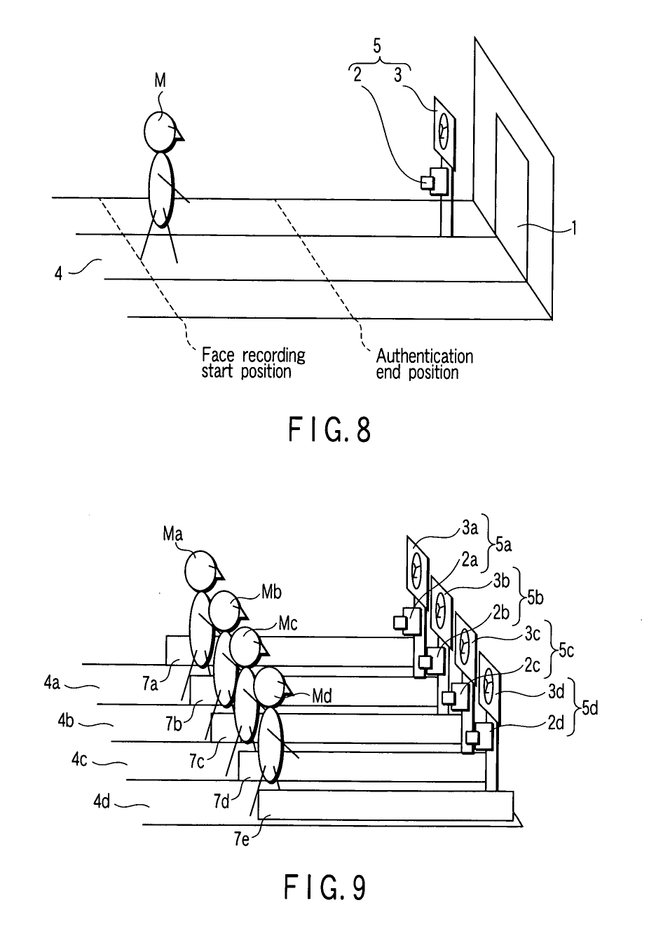

First, another example of face authentication will be explained below with reference to FIGS. 8 to 11. In face authentication which checks whether a visitor is a preregistered person by using a face image, recording the front face of a person is normally important to increase the accuracy of face authentication. As shown in FIG. 8, therefore, a camera 2 and display unit 3 are arranged close to each other to record a front face by guiding a visitor M to watch the display unit 3. More specifically, the display unit 3 zooms and displays the recorded face of the visitor M.

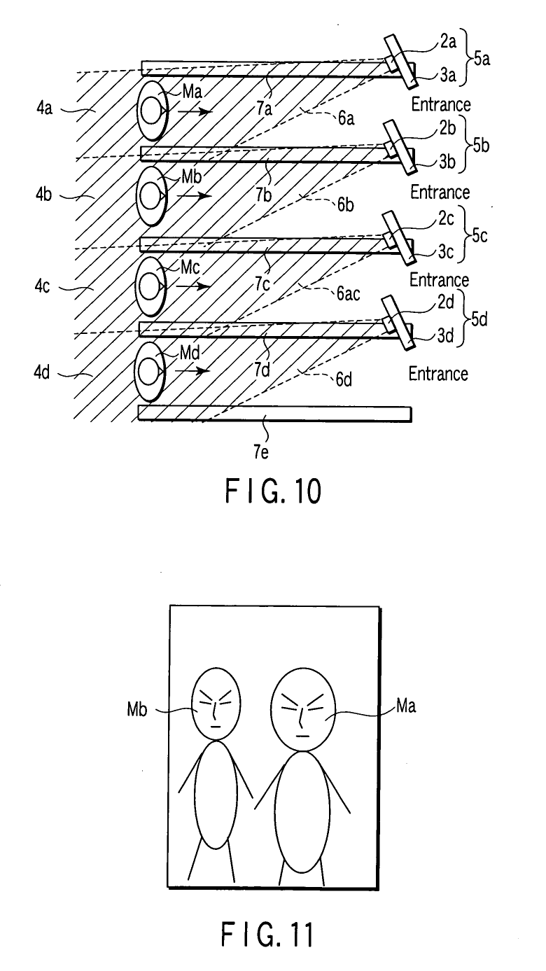

To install the face authentication apparatus as shown in FIG. 8 in a place where many visitors pass, it is possible to arrange a plurality of apparatuses in parallel as shown in FIG. 9 and authenticate the faces of a plurality of visitors at once. FIG. 10 is a plan view of FIG. 9.

FIGS. 9 and 10 illustrate an example in which four face authentication apparatuses are arranged in parallel. Visitors Ma, Mb, Mc, and Md respectively pass through parallel passages 4a, 4b, 4c, and 4d. Note that these visitors pass from the left to the right in the drawing. Face authentication apparatuses 5a, 5b, 5c, and 5d respectively authenticate the faces of the visitors Ma, Mb, Mc, and Md. The face authentication apparatuses 5a, 5b, 5c, and 5d respectively have cameras 2a, 2b, 2c, and 2d. In addition, the face authentication apparatuses 5a, 5b, 5c, and 5d respectively have display units 3a, 3b, 3c, and 3d. Recording fields 6a, 6b, 6c, and 6d respectively indicate recording directions corresponding to the cameras 2a, 2b, 2c, and 2d.

Passage partitions 7a, 7b, 7c, 7d, and 7e are plates which partition the passages 4a, 4b, 4c, and 4d. The passage partitions prevent visitors who have once entered passages from moving to adjacent passages.

Problems will be explained in detail below. For example, the visitor Mb passing along the passage 4b shown in FIG. 10 enters the recording field 6a of the camera 2a of the face authentication apparatus 5a, so an input image from the camera 2a contains the face of the visitor Mb in the adjacent passage 4b as shown in FIG. 11. In this case, the face authentication apparatus 5a may authenticate the visitor Mb by mistake.

To solve this problem, it is possible to check whether a visitor in an input image is a person in a passage of interest by obtaining the position of the visitor by stereoscopic vision. However, this method requires the recording timings of a plurality of cameras to be the same. This increases both the apparatus cost and processing cost.

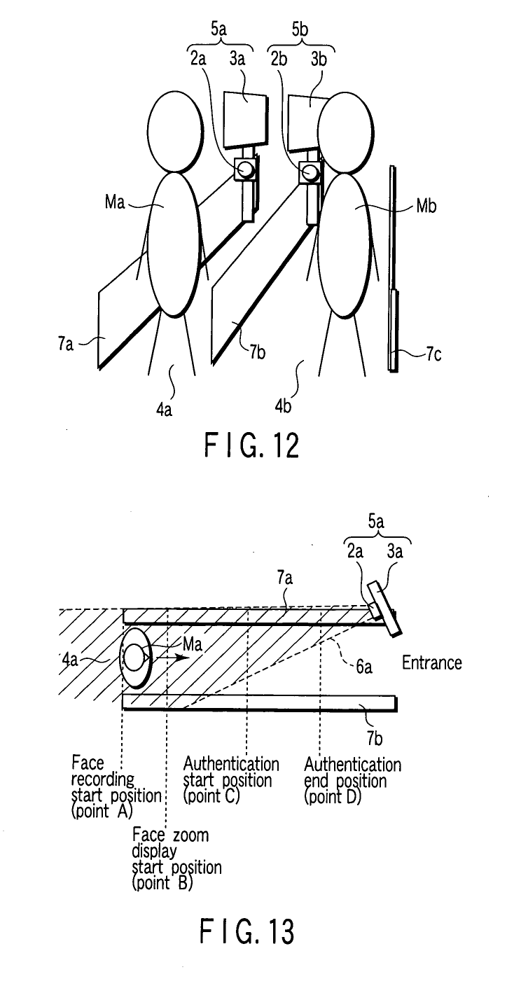

FIG. 12 shows a state in which the display units 3a and 3b are viewed from the passages 4a and 4b. As is apparent from FIG. 12, both the display units 3a and 3b come in sight of the visitor Mb, so the visitor Mb may watch the display unit 3a. If the visitor Mb turns his or her face to the display unit 3a, the camera 2b cannot obtain a front face of the visitor Mb. If a front face cannot be stably obtained, the accuracy of face authentication decreases.

The operation timings of the face authentication apparatus will be explained below with reference to FIG. 13. FIG. 13 specifically shows the passage 4a shown in FIG. 10. In a face recording start position A, the camera 2a starts recording the face of the visitor Ma. In an authentication end position D, the display unit 3a displays a message indicating whether face authentication is successful or unsuccessful. “Face authentication is successful” means that the face authentication apparatus 5a determines that the visitor is a preregistered person. “Face authentication is unsuccessful” means that the face authentication apparatus 5a cannot determine that the visitor is a preregistered person.

If face authentication is successful, the visitor Ma moves toward the entrance (door). If face authentication is unsuccessful, the visitor Ma returns from the authentication end position D in the direction opposite to the passing direction (from the right to the left in the drawing). While the visitor Ma who has not passed face authentication is returning the passage 4a, a traffic jam occurs in the passage, so the face authentication apparatus 4a cannot be efficiently used.

An embodiment of the present invention will be explained below with reference to the accompanying drawing.

Note that in the following explanation, the same reference numerals as in FIGS. 8 to 13 described above denote the same parts.

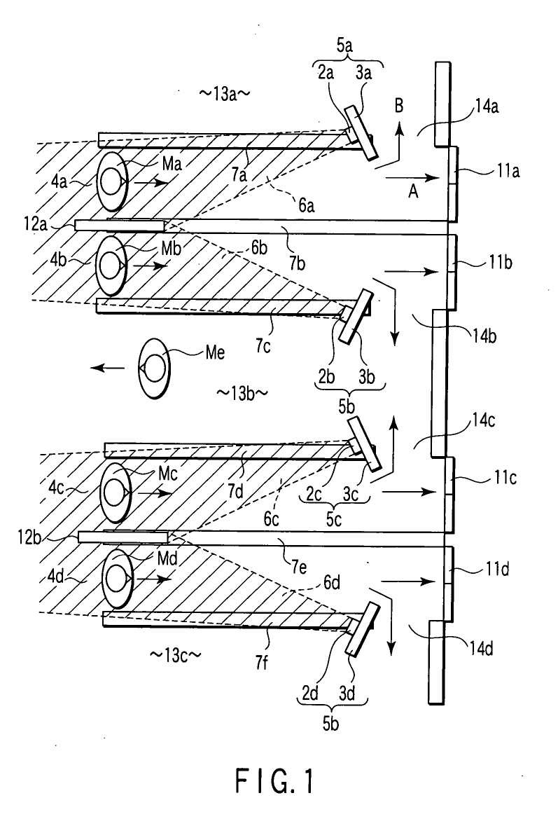

FIG. 1 schematically shows the configuration of a gate management system to which a face authentication system according to this embodiment is applied. Referring to FIG. 1, a plurality of (four in this example) parallel passages 4a, 4b, 4c, and 4c respectively communicate with gate apparatuses (entrance/exit gates) 11a, 11b, 11c, and 11d installed at the entrance of an entrance/exit target area (e.g., a room or facility). Visitors (persons) Ma, Mb, Mc, and Md respectively pass along the passages 4a, 4b, 4c, and 4d toward the gate apparatuses 11a, 11b, 11c, and 11d (from the left to the right in the drawing).

The passages 4a, 4b, 4c, and 4d have passage partitions (plates) 7a, 7b, 7c, 7d, 7e, and 7f which prevent visitors who have once entered passages from moving to adjacent passages.

Face authentication apparatuses 5a, 5b, 5c, and 5d are respectively installed on the sides of the passages 4a, 4b, 4c, and 4d and in positions before and close to the gate apparatuses 11a, 11b, 11c, and 11d. The face authentication apparatuses 5a, 5b, 5c, and 5d respectively include video cameras (to be simply abbreviated as cameras hereinafter) 2a, 2b, 2c, and 2d as image sensing means for recording images containing at least the faces of the visitors Ma, Mb, Mc, and Md, and display units 3a, 3b, 3c, and 3d as display means for displaying, e.g., the present face authentication statuses to the visitors Ma, Mb, Mc, and Md. The face authentication apparatuses 5a, 5b, 5c, and 5d respectively authenticate the faces of the visitors Ma, Mb, Mc, and Md.

Assume that two adjacent passages make a pair and two face authentication apparatuses installed in these two passages also make a pair. In this example, the passages 4a and 4b, the face authentication apparatuses 5a and 5b, the passages 4c and 4d, and the face authentication apparatuses 5c and 5d make pairs. As shown in FIG. 1, recording fields 6a and 6b of the cameras 2a and 2b of the paired face authentication apparatuses 5a and 5b point to each other's passages, and recording fields 6c and 6d of the cameras 2c and 2d of the paired face authentication apparatuses 5c and 5d point to each other's passages. That is, the recording direction of the camera 2a installed in the passage 4a points to the passage 4b, and the recording direction of the camera 2b installed in the passage 4b points to the passage 4a. Also, the display screens of the display units 3a, 3b, 3c, and 3d respectively point to the same directions as the recording fields 6a, 6b, 6c, and 6d of the corresponding cameras 2a, 2b, 2c, and 2d. That is, the camera 2a and display unit 3a corresponding to the face authentication apparatus 5a are paired, and the display direction of the display unit 3a is set to point to the same direction as the recording direction of the camera 2a.

Blind plates 12a and 12b stand upright between the paired passages 4a and 4b and between the paired passages 4c and 4d, respectively. Each of the blind plates 12a and 12b is a blind plate which prevents a visitor passing through one passage from entering the recording field of the camera of the face authentication apparatus in the other passage. More specifically, the blind plates 12a and 12b are respectively installed on the passage partitions 7b and 7e.

The blind plate 12a prevents the camera 2a from recording the visitor Mb passing through the passage 4b, and prevents the camera 2b from recording the visitor Ma passing through the passage 4a. Similarly, the blind plate 12b prevents the camera 2c from recording the visitor Md passing through the passage 4d, and prevents the camera 2d from recording the visitor Mc passing through the passage 4c. Also, the blind plate 12a is formed on only a portion of the passage partition 7b, and does not cover the whole of the passages 4a and 4b (covers only parts of the passages 4a and 4b). Likewise, the blind plate 12b is formed on only a portion of the passage partition 7e, and does not cover the whole of the passages 4c and 4d (covers only parts of the passages 4c and 4d). The blind plates 12a and 12b are arranged as described above so as not to obstruct the view of, e.g., one security guard who checks the whole of the passages 4a, 4b, 4c, and 4d.

Return passages 13a, 13b, and 13c which allow visitors who have not passed face authentication to return are respectively formed outside the paired passages 4a and 4b, between the paired passages 4a and 4b and the paired passages 4c and 4d, and outside the paired passages 4c and 4d. In the example shown in FIG. 1, a visitor Me who has not passed face authentication walks along the return passage from the right to the left in the drawing.

As shown in FIG. 1, if the visitor Ma has passed face authentication in the passage 4a, the visitor Ma passes through the gate apparatus 11a as indicated by an arrow A near the entrance of the passage 4a. If the visitor Ma has not passed face authentication, the visitor Ma moves to the return passage 13a through a connection gate 14a formed near the entrance of the passage 4a as indicated by an arrow B near the entrance, and returns in the direction (from the right to the left in the drawing) opposite to that when he or she enters. This similarly applies to the passages 4b, 4c, and 4d.

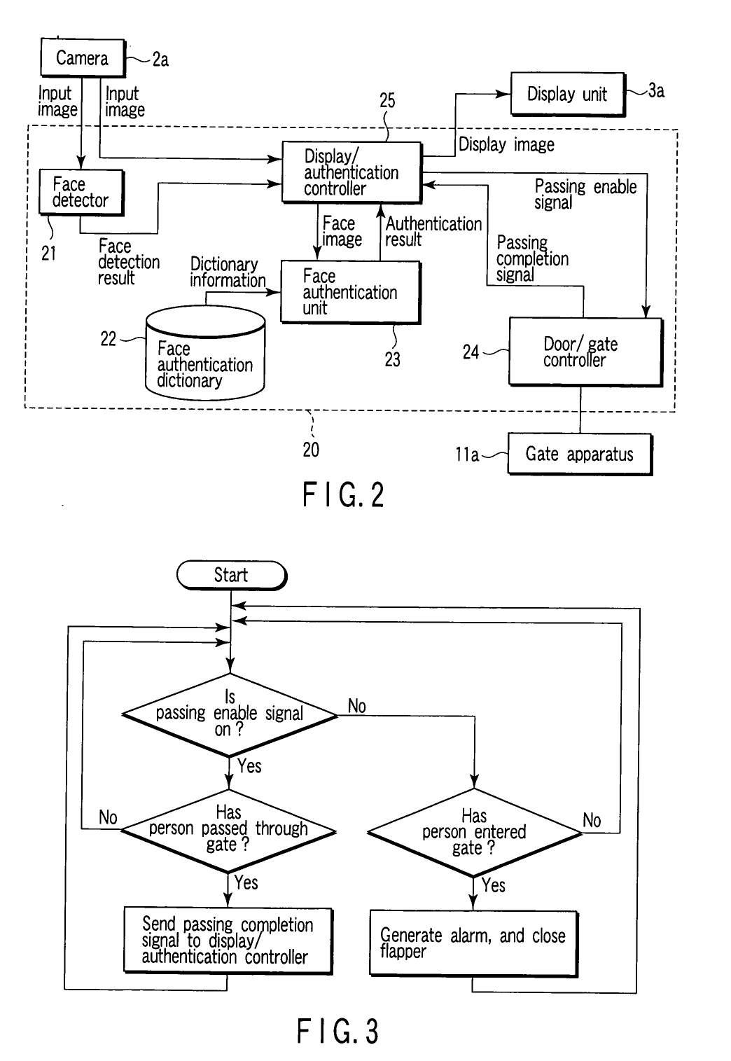

The arrangement of the face authentication apparatuses 5a, 5b, 5c, and 5d will be explained below with reference to FIG. 2. Note that the face authentication apparatuses 5a, 5b, 5c, and 5d have the same arrangement, so only the face authentication apparatus 5a will be explained as a representative.

The face authentication apparatus 5a comprises the camera 2a, the display unit 3a, and a processor 20. The processor 20 comprises a face detector 21, face authentication dictionary 22, face authentication unit 23, gate controller 24, and display/authentication controller 25. The face detector 21 is a face detecting means for detecting the face region of the visitor Ma from each image recorded by the camera 2a. The face authentication dictionary 22 is a dictionary storage means in which a plurality of pieces of dictionary information are preregistered (prestored). The face authentication unit 23 is an authenticating means for determining whether the visitor Ma is a preregistered person by collating an image of the face region detected by the face detector 21 with the dictionary information preregistered in the face authentication dictionary 22. The controller 24 is a gate control means for controlling the gate apparatus 11a on the basis of the determination result from the face authentication unit 23. The display/authentication controller 25 is a control means for controlling the overall operation.

The individual constituent elements will be explained in detail below.

The face detector 21 detects a region where the face exists in an image obtained from the camera 2a. The face region detecting process uses, e.g., a method described in reference (Mita, Kaneko, and Hori, “Proposal of Spatial Difference Probability Template Suited to Collation of Images Including Fine Differences”, The 9th Image Sensing Symposium Lecture Papers, SSII03, 2003). This method forms detection dictionary patterns from face learning patterns beforehand, and searches an input image for a pattern having high similarity to the dictionary patterns.

The face authentication unit 23 checks whether the image in the face region from the face detector 21 is preregistered. More specifically, as described in, e.g., Jpn. Pat. Appln. KOKAI Publication No. 2001-266152, the face authentication unit 23 prepares face images of registrants (visitors), and prestores (preregisters) unique feature information extracted from the face images in the face recognition dictionary 22. The face authentication unit 23 then collates an image (feature information) of a face region detected by the face detector 21 with the dictionary information preregistered in the face recognition dictionary 22, thereby obtaining the similarity between them. If the obtained similarity is equal to or larger than a preset threshold value, the face authentication unit 23 determines that the visitor Ma is a preregistered person. If the obtained similarity is smaller than the threshold value, the face authentication unit 23 determines that the visitor Ma is not a preregistered person.

When the gate apparatus 11a is a door, the gate controller 24 unlocks the door if a passing enable signal from the display/authentication controller 25 is ON. When the gate apparatus 11a is a flapper, the gate controller 24 generates an alarm sound and closes the flapper if the visitor Ma enters the gate apparatus 11a although the passing enable signal is OFF, thereby inhibiting the passing of the visitor Ma. More specifically, the gate controller 24 performs control as indicated by a flowchart shown in FIG. 3.

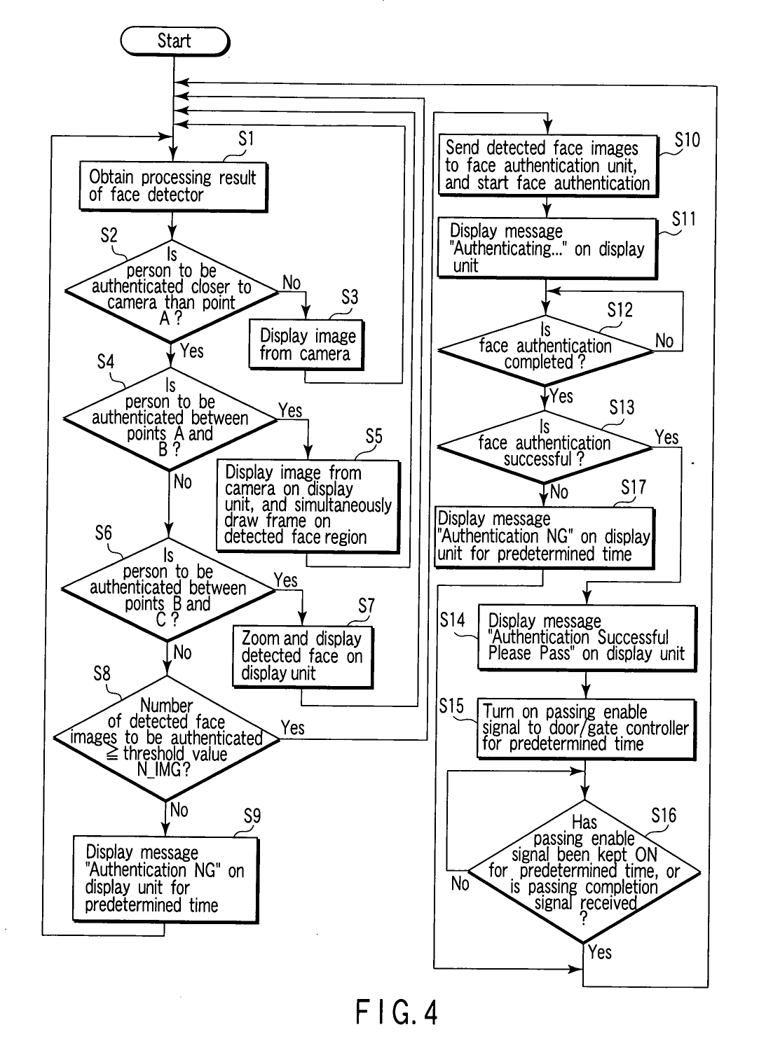

The display/authentication controller 25 controls the whole apparatus. A flowchart in FIG. 4 shows the procedure of processing. This flowchart shown in FIG. 4 will be explained below. Assume that points A, B, and C shown in FIG. 4 are points in the passage 4a shown in FIG. 13.

First, the display/authentication controller 25 acquires the processing result of the face detector 21 (step S1), and checks whether the person (visitor Ma) to be authenticated is closer to the camera 2a than the point A (step S2). If the visitor Ma is not closer to the camera 2a than the point A, the display/authentication controller 25 displays an image from the camera 2a on the display unit 3a (step S3), and returns to step S1 to repeat the same operation.

If the result of the check in step S2 indicates that the face region of the visitor Ma is detected and the visitor Ma having this face is closer to the camera 2a than the point A, the display/authentication controller 25 regards the visitor Ma as an object of face authentication, and checks whether the visitor Ma is between the points A and B in the passage 4a (step S4). Note that the display/authentication controller 25 predicts the position of a person from, e.g., the size of the detected face.

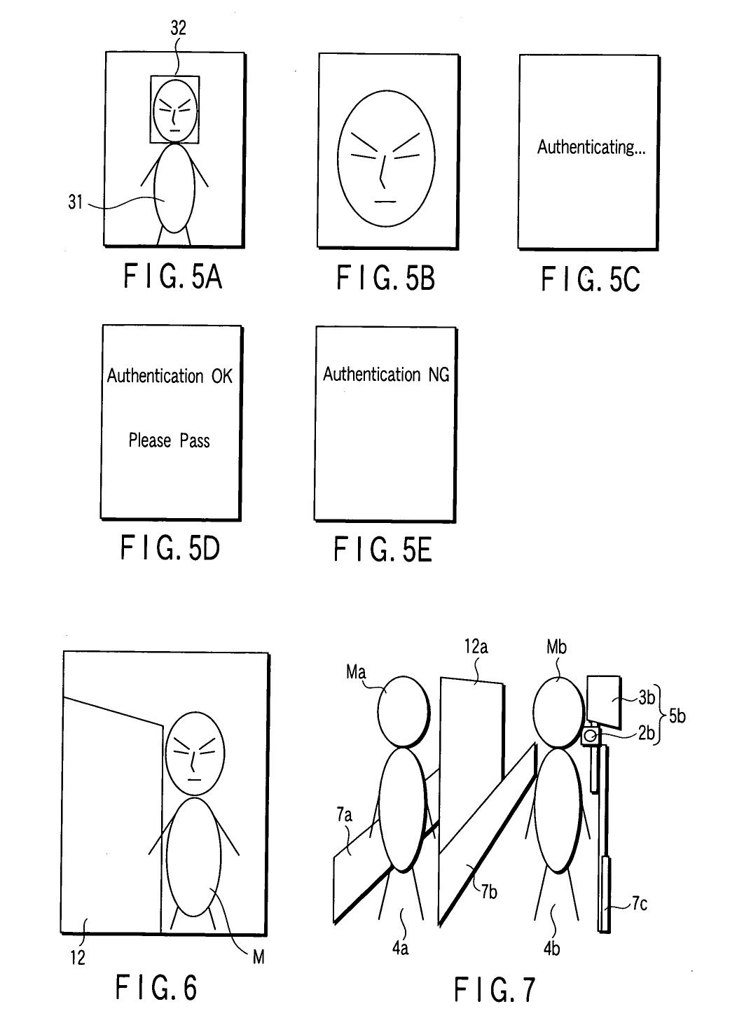

If the result of the check in step S4 indicates that the visitor Ma to be authenticated is between the points A and B, as shown in FIG. 5A, the display/authentication controller 25 displays an overall input image 31 obtained from the camera 2a on the display unit 3a, and simultaneously displays a frame 32 indicating the detected face region (step S5). After that, the display/authentication controller 25 returns to step S1 to repeat the same operation.

If the result of the check in step S4 indicates that the visitor Ma to be authenticated is not between the points A and B, the display/authentication controller 25 checks whether the visitor Ma is between the points B and C in the passage 4a (step S6). If the visitor Ma is between the points B and C, as shown in FIG. 5B, the display/authentication controller 25 displays the detected face image in an enlarged scale on the display unit 3a (step S7), and returns to step S1 to repeat the same operation.

If the result of the check in step S6 indicates that the visitor Ma is not between the points B and C, the display/authentication controller 25 checks whether the number of collected face images of the detected object to be authenticated is equal to or larger than a minimum predetermined number (N_IMG) necessary for authentication (step S8). If the number of collected face images of the object to be authenticated is smaller than the predetermined number (N_IMG), the display/authentication controller 25 displays a message representing the failure of authentication on the display unit 3a (step S9), and returns to step S1 to repeat the same operation.

If the result of the check in step S8 indicates that the number of face images of the object to be authenticated is equal to or larger than the predetermined number (N_IMG), the display/authentication controller 25 supplies the images (face images) of the face region detected by the face detector 21 to the face authentication unit 23, and starts face authentication (step S10). As shown in FIG. 5C, the display/authentication controller 25 displays a message “Authenticating . . . ” on the display unit 3a (step S11), and waits until the face authentication process is complete (step S12).

If the face authentication process is complete, the display/authentication controller 25 checks whether the authentication result is successful or unsuccessful (step S13). If the authentication result is successful, as shown in FIG. 5D, the display/authentication controller 25 displays a message “Authentication OK Please Pass” on the display unit 3a (step S14), and turns on the passing enable signal to the gate controller 24 for a predetermined time (step S15). This allows the visitor Ma to pass through the gate apparatus 11a .

After that, the display/authentication controller 25 waits until a predetermined time elapses since the passing enable signal is turned on or a passing completion signal is received from the gate controller 24 (step S16). If the predetermined time has elapsed since the passing enable signal is turned on or the passing completion signal is received from the gate controller 24, the display/authentication controller 25 returns to step S1 to repeat the same operation.

If the result of the check in step S13 indicates that the authentication result is unsuccessful, as shown in FIG. 5E, the display/authentication controller 25 displays a message “Authentication NG” on the display unit 3a for a predetermined time (step S17), and returns to step S1 to repeat the same operation.

As explained above, this embodiment can reduce the number of blind plates. That is, two face authentication apparatuses and two passages are paired, and the cameras of the paired face authentication apparatuses are turned to each other's passages. Therefore, a blind plate need only be installed between the two passages making a pair. This makes the number of blind plates smaller than that in the conventional arrangement as shown in FIG. 9. This arrangement shown in FIG. 9 requires blind plates between all passages.

Also, no person in a passage other than a passage of interest appears in an input image. Therefore, no visitor in an adjacent passage is detected as an object of authentication by mistake. That is, as indicated by an example of an input image shown in FIG. 6, the input image does not contain any person in an adjacent passage owing to the blind plate 12, and contains only a visitor M in a passage of interest. Consequently, no visitor in an adjacent passage is detected as an object of authentication by mistake.

In addition, a visitor can easily find a target display unit to watch, so the direction of the face of the visitor stabilizes. This increases the authentication accuracy. FIG. 7 shows the display unit 3b viewed in the directions of the passages 4a and 4b. Since the blind plate 12a prevents the visitor Mb from watching the display unit 3a in the adjacent passage 4a, the visitor Mb can readily watch the display unit 3b carefully and stably turns his or her face to the display unit 3b. Consequently, the camera 2b can stably record a front face, so the accuracy of face authentication increases.

It is also possible to prevent a traffic jam when face authentication is unsuccessful. That is, return passages are formed for visitors who have not passed face authentication. Therefore, a visitor who has not passed face authentication need not return the passage for authentication unlike in the conventional system, and this prevents a traffic jam.

Furthermore, the insta11a tion space can be reduced because the return passages for visitors who have not passed face authentication can be shared. That is, when a plurality of paired passages are arranged in parallel, adjacent pairs can share one return passage. This effectively reduces the insta11a tion space.

The passages 4a, 4b, 4c, and 4d of the face authentication system of this embodiment described above can also be autowalks or escalators. Since a person often stands still on an autowalk or escalator, it is possible to stably obtain a person image and increase the authentication accuracy.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A face authentication system which authenticates faces of persons passing through at least two parallel passages before the persons reach predetermined positions, comprising:
a plurality of image sensing means arranged in the predetermined positions of said plurality of passages to record images of persons passing through the passages;
a plurality of face authenticating means for checking whether the persons are preregistered persons, on the basis of the images obtained from said plurality of image sensing means; and
a blind plate installed between every two adjacent passages making a pair among said plurality of passages to prevent the image sensing means installed in one passage to record a person passing through the passage from recording a person passing through the other passage,
wherein a recording direction of the image sensing means installed in one passage points to the other passage.

2. A system according to claim 1, which further comprises a plurality of display means corresponding to said plurality of face authenticating means to display present face authentication statuses of persons passing through the passages, and
in which one image sensing means and one display means corresponding to one face authenticating means are paired, and a display direction of the display means of the pair is set in the same direction as a recording direction of the image sensing means of the pair.

3. A system according to claim 1, wherein a return passage which allows a person who has not passed face authentication to return in a direction opposite to a passing direction is formed outside each of the two paired passages.

4. A gate management system which authenticates faces of persons passing through at least two parallel passages before the persons reach a plurality of entrance/exit gates, and controls opening/closing of said plurality of entrance/exit gates on the basis of authentication results, comprising:
a plurality of image sensing means arranged in predetermined positions corresponding to the entrance/exit gates of said plurality of passages to record images of persons passing through the passages;
a plurality of face authenticating means for checking whether the persons are preregistered persons, on the basis of the images obtained from said plurality of image sensing means;
a plurality of gate control means for controlling opening/closing of said plurality of entrance/exit gates, on the basis of determination results from said plurality of face authenticating means; and
a blind plate installed between every two adjacent passages making a pair among said plurality of passages to prevent the image sensing means installed in one passage to record a person passing through the passage from recording a person passing through the other passage,
wherein a recording direction of the image sensing means installed in one passage points to the other passage.

5. A system according to claim 4, which further comprises a plurality of display means corresponding to said plurality of face authenticating means to display present face authentication statuses of persons passing through the passages, and
in which one image sensing means and one display means corresponding to one face authenticating means are paired, and a display direction of the display means of the pair is set in the same direction as a recording direction of the image sensing means of the pair.

6. A system according to claim 4, wherein a return passage which allows a person who has not passed face authentication to return in a direction opposite to a passing direction is formed outside each of the two paired passages.
